(19) United States
(12) Patent Application Publication
(10) Pub. No.: US 2026/0080099 A1
(43) Pub. Date: Mar. 19, 2026

(54) Data Preparation Engine(s) For Curating Secure And Compliant Data Collections From Distributed Sources

(71) Applicant: NetApp, Inc., San Jose, CA (US)

(72) Inventors: Phani Srikanth Bhavani Sankar, Hyderabad (IN); Micky Fridman, Lehavot Haviva (IL); Darshan Adiga Haniya Narayana, Bengaluru (IN); Arunkumar Gururajan, Sammamish, WA (US); Girish Chandrashekar, Bengaluru (IN); Efrat Tzipora Gutman, Petah Tikva (IL); Nadav Friedman, Ramat Gan (IL); Nehorai Kikozashvili, Ashdod (IL); Noga Horowitz, Ganai Tikva (IL); Ad Shapira, Jerusalem (IL); Nir Lieber, Tel Aviv (IL); Shivakarthik Subramanyam, Dublin, CA (US); Gagan Gulati, Sammamish, WA (US)

(73) Assignee: NetApp, Inc., San Jose, CA (US)

(21) Appl. No.: 19/324,580

(22) Filed: Sep. 10, 2025

(30) Foreign Application Priority Data
Sep. 16, 2024 (IN) 202441069911

(51) Int. Cl. G06F 21/62; G06F 16/22; G06F 16/242; G06F 21/16; G06F 21/31

(52) U.S. Cl. CPC G06F 21/6254; G06F 16/22; G06F 16/243; G06F 21/16; G06F 21/316; G06F 2221/2141

(57) ABSTRACT

Various embodiments of the present technology generally relate to systems and methods for providing a data preparation engine for curating secure and compliant data collections from distributed storage systems. In an aspect, a data preparation engine receives a query from a client device and determines files from one or more distributed sources based on the query. The data preparation engine determines sensitive data within the files and anonymizes the sensitive data while preserving context and integrity of the underlying information. The data preparation engine generates a data collection including the files with anonymized sensitive data. The data collection may then be deployed to downstream applications or workflows, such as used to generate curated data sets for training of artificial intelligence applications. Once deployed, the data preparation engine may continuously monitor the distributed sources for changes to data within the files and automatically update data collections in real-time.

### CROSS-REFERENCED APPLICATIONS

This application claims priority to Indian Patent Application number 202441069911, titled DATA PREPARATION ENGINE(S) FOR CURATING SECURE AND COMPLIANT DATA COLLECTIONS FROM DISTRIBUTED SOURCES, filed on Sep. 16, 2024, which is hereby incorporated by reference in its entirety.

### TECHNICAL FIELD

Various embodiments of the present technology generally relate to distributed storage systems. More specifically, embodiments of the present technology relate to systems and methods for data discovery and anonymization techniques for curating data collections from distributed storage systems (on-premises and cloud-based) to be used within downstream applications, such as machine-learning (ML) or artificial intelligence (AI) workflows.

### BACKGROUND

In today's digital landscape, organizations manage an immense volume of data, often referred to as their “data estate.” This vast repository encompasses a wide range of information, from structured databases to unstructured content such as documents, emails, and multimedia. What makes managing this data estate even more complex is its distribution across multiple storage systems, both on-premises and cloud-based. These storage environments can include everything from local servers to distributed cloud platforms and hybrid systems, making it essential for organizations to adopt strategies that ensure data is accessible, secure, and organized, despite its widespread nature.

One major setback of modern data estate structures is the limited ability for effective data discovery, which directly impacts an organization's capacity to curate cohesive data collections for downstream applications. With data scattered across various storage systems and formats—often isolated in silos—finding and accessing the right data becomes a time-consuming and inefficient process. This fragmentation hampers efforts to aggregate and organize data in a meaningful way, making it difficult, such as for data personas, to compile consistent datasets for analytics, machine learning models, or business intelligence tools. The inability to create unified, comprehensive collections of data not only slows down innovation but also limits an organization's potential to extract valuable insights and maintain compliance, undermining their competitive edge.

While there are current techniques and methodologies for retrieving data for collection curation, these techniques lack sufficient visibility into the data they handle, which can lead to inadequate protection of sensitive or proprietary information. As these techniques typically involve retrieving data from vast datasets within an organization's larger data estate, the failure to properly identify and protect confidential data can result in significant issues. These include difficulties in properly sanitizing data, ensuring robust application security, and adhering to compliance with regulatory policies. Data integrity, data completeness, or data sanity, is a concern, as inaccuracies or biases in retrieved data can lead to flawed outputs in downstream applications, such as in ML workflows. Moreover, without adequate identification and visibility into sensitive data, current techniques might inadvertently expose or misuse sensitive information, thereby resulting in a security risk of a downstream application. Failure to sanitize sensitive data may also cause organizations to be non-compliant or not able to ensure compliance with respective compliance or governing policies, such as data privacy laws like the General Data Protection Regulation (GDPR), the California Consumer Privacy Act (CCPA), Health insurance Portability and Accountability Act (HIPPA), and the like.

Accordingly, there exists a need for improved enhanced and adaptive data preparation engine(s) for curation of secure and compliant data collections from distributed storage systems, as provided herein.

The information provided in this section is presented as background information and serves only to assist in any understanding of the present disclosure. No determination has been made and no assertion is made as to whether any of the above might be applicable as prior art with regard to the present disclosure.

### BRIEF DESCRIPTION OF THE DRAWINGS

The accompanying drawings, which are incorporated into and constitute a part of this specification, illustrate one or more certain aspects and, together with the description of the example, serve to explain the principles and implementations of the certain examples.

FIG. 1 illustrates an example operational environment for a system for providing a data preparation engine, according to an embodiment herein.

FIG. 2 illustrates an example system in which a data persona curates a data collection using the data preparation engine, according to an embodiment herein.

FIG. 3 illustrates an example process for providing a data preparation engine, according to an embodiment herein.

FIG. 4 illustrates an example data embedding module, according to an embodiment herein.

FIG. 5 illustrates an example graphical user interface (GUI) for providing files identified by the data preparation engine as relevant to a query, according to an embodiment herein.

FIG. 6 illustrates an example of sensitive information that is anonymized within a respective file by a data preparation engine, according to an embodiment herein.

FIG. 7A illustrates an example prompt for requesting access to a secure file, according to an embodiment herein.

FIG. 7B illustrates an example access request for accessing a secure file, according to an embodiment herein.

FIG. 8 illustrates an example GUI illustrating a subset of files selected for a data collection, according to an embodiment herein.

FIG. 9 illustrates an example GUI of a data collection, according to an embodiment herein.

FIG. 10 illustrates an example prompt provided to a data persona for deploying a data collection, according to an embodiment herein.

FIG. 11 illustrates an example prompt showing changes detected by the data preparation engine, according to an embodiment herein.

FIG. 12 illustrates an example GUI identifying changes made to a data collection, according to an embodiment herein.

FIG. 13 shows an example computing device suitable for providing one or more steps of a data preparation process, according to an embodiment herein.

Some components or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

In today's digital landscape, organizations manage an immense volume of data, often referred to as their “data estate,” which encompasses both structured databases and unstructured content such as documents, emails, and multimedia. This data is typically distributed across multiple storage systems, from on-premises servers to cloud platforms and hybrid environments, making it essential for organizations to adopt strategies that ensure data remains accessible, secure, and organized. However, a significant challenge of this complex data estate structure is the limited ability for effective data discovery, which hampers an organization's capacity to curate cohesive data collections for downstream applications. With data scattered across various systems and often siloed in different formats, finding, discovering and accessing the right information becomes inefficient, complicating efforts to compile consistent datasets for analytics, machine learning models, and business intelligence tools. As a result, the inability to create unified data collections not only slows down innovation but also limits an organization's ability to extract valuable insights and maintain compliance, ultimately affecting their competitive edge.

There are several modern techniques for retrieving data and insights from distributed sources and curating cohesive data collections for downstream workflows, including methods like Retrieval-Augmented Generation (RAG). These techniques enable organizations to query vast, decentralized data estates and pull relevant information for downstream tasks such as machine learning, natural language processing, and analytics. By integrating retrieval mechanisms with generative AI models, RAG and similar approaches allow for dynamic data discovery and insight generation. However, these techniques face numerous challenges, such as data silos, inconsistencies in formats, and varying levels of data quality which can impede retrieval accuracy and efficiency.

Another shortcoming of current data retrieval techniques for curating collections is the lack of visibility into the retrieved data, especially when it comes to sensitive information. As data is pulled from distributed sources, it can be difficult to track and classify the content in real-time, increasing the risk of exposing personally identifiable information (PII), proprietary data, or other confidential materials. Traditional retrieval methods often lack the granular oversight necessary to identify and label sensitive data, making it challenging to apply appropriate governance, security controls, or compliance measures. This lack of transparency not only raises concerns about data privacy but also complicates auditing processes, leaving organizations vulnerable to regulatory penalties and reputational damage. Addressing this gap is important to ensuring that data retrieval techniques are both effective and secure in managing complex data estates.

In addition to the lack of visibility into retrieved data, current data retrieval techniques often fall short in sufficiently sanitizing data, particularly when dealing with sensitive or confidential information. While these methods are designed to extract relevant data quickly, they frequently lack robust mechanisms for automatic data cleansing or redaction. This can result in the inclusion of sensitive content such as PII, financial data, or proprietary business details in downstream workflows, posing significant compliance and security risks. Furthermore, without thorough sanitization processes, inconsistent or erroneous data can make its way into curated collections, leading to unreliable outputs in downstream analytics, machine learning models, and other applications.

The failure to properly identify and sanitize sensitive data can lead to several negative consequences, particularly in the realm of regulatory compliance. When organizations do not effectively cleanse their data, they risk exposing PII, health records, financial details, or other sensitive content that is subject to strict data protection laws such as GDPR, HIPAA, or the CCPA. This lack of oversight makes it difficult to ensure compliance with these regulatory and governing policies, leaving organizations vulnerable to substantial legal penalties, fines, and reputational damage. Additionally, the presence of unfiltered sensitive data in downstream applications can lead to data breaches or misuse, further compounding security risks. Beyond legal and financial repercussions, failure to sanitize data undermines the integrity of analytics and machine learning models, as improperly handled data can introduce bias or inaccuracies, leading to flawed insights and business decisions. Thus, robust data sanitization is important not only for compliance but also for maintaining data quality and trust.

To address the challenges of creating cohesive, sanitized datasets for integration into downstream applications, in particular AI workflows, current approaches often rely on synthetic datasets. These synthetic datasets are artificially generated data that mimic the statistical properties and patterns of real-world data without containing actual sensitive information. Organizations may turn to synthetic data generation techniques to circumvent the complexities of data discovery, sanitization, and compliance management across their distributed data estates. While synthetic datasets can provide a seemingly convenient solution for training AI models without exposing sensitive information, they introduce significant limitations that may compromise the effectiveness and reliability of downstream applications.

The use of synthetic datasets over datasets generated from an organization's own real data, however, presents several notable drawbacks. Synthetic data may lack the nuanced patterns, edge cases, and contextual richness that exist in authentic organizational data, potentially leading to AI models that perform well in controlled environments but fail to generalize effectively to real-world scenarios. Additionally, synthetic datasets may not capture the specific domain knowledge, business processes, and unique characteristics that are inherent in an organization's actual data estate, resulting in AI models that may be less relevant or applicable to the organization's specific use cases. Furthermore, relying solely on synthetic data can prevent organizations from leveraging the valuable insights and competitive advantages that may be derived from their proprietary data assets. The disconnect between synthetic training data and real operational data can also lead to model drift and reduced performance over time, as the AI systems encounter data patterns and scenarios that were not adequately represented in the synthetic training sets.

To address the shortcomings of traditional systems and techniques for generating data collections from distributed sources for use in downstream applications, example data preparation engine(s) are provided herein. As will be expanded on below, the data preparation engine provided herein performs data discovery over a customer's or organization's entire data estate, which may include multiple, distributed storage systems that may include any combination of on-premises, cloud, and hybrid systems. Responsive to identifying relevant data, the data preparation engine may identify sensitive information and sanitize or anonymize the sensitive data respectively. Importantly, the data preparation engine may sanitize the sensitive data without convoluting or impacting the context of the data within the document, thereby ensuring the data's integrity within a downstream application. Additionally, the data preparation engine can identify relevant data privacy and compliance policies or regulations (hereinafter referred to as “policies”) for data and provide visibility into these policies for a user curating the data collection (hereinafter referred to as “a data persona”).

Beyond identifying and sanitizing sensitive data, the data preparation engine may automatically identify, sanitize, and integrate new data into an established data collection as new files are being added to the distributed storage systems. This allows for real-time classification, sanitization, and indexing of the data, ensuring that data collections remain current and reflect the most up-to-date information available within the organization's data estate. As the data preparation engine continuously monitors the source data, it can detect when new content is added that matches the criteria of existing data collections, automatically processing this new data through the same rigorous identification and anonymization protocols applied to the original dataset. This real-time updating capability ensures that downstream applications always have access to the most comprehensive and compliant data available, without requiring manual intervention from the data persona for each new file addition.

Additionally, the data preparation engine may allow data personas to find, discover and create data collections from data across the hybrid multi-cloud data estate of an organization, regardless of the data persona's personal ability and credentials to access the overall dataset or source. That is, the data preparation engine may include role-based access control (RBAC) for accessing and using data within a respective data collection. For example, the data preparation engine may identify a document for which the data persona does not have authorization to access. Responsively, the data preparation engine may coordinate with a data protection officer (DPO) to grant access for the data persona to the document for the purposes of the data collection.

As will become apparent in the below description, the data preparation engine provided herein provides for a wide range of technical effects, advantages, and/or improvements to computing systems and components. For example, by incorporating sensitive data identification, thorough sanitization, document-level access controls, and visibility into regulatory and policy compliance the data preparation engine offers numerous benefits and technical improvements for computing systems. By automatically identifying and sanitizing sensitive data, the data preparation engine mitigates risks associated with data breaches and ensures compliance with regulations such as GDPR, HIPAA, and CCPA. This enhances security and reduces the likelihood of costly legal penalties. By including a DPO and RBAC, the data preparation engine provides access control on a per-document and per-user basis which allows for precise data curation, ensuring that only authorized individuals can view or handle sensitive content, which strengthens data governance and operational efficiency.

Additionally, by providing visibility into regulatory compliance the data preparation engine helps organizations maintain an audit trail, such as for monitoring purpose, and demonstrate adherence to legal and policy requirements, fostering transparency and accountability. Moreover, on the technical side the data preparation engine improves data integrity by filtering out inaccuracies and bias, while also enhancing performance by streamlining data access and reducing the complexity of managing vast, distributed data estates. Overall, the data preparation engine contributes to a more secure, compliant, and efficient data management environment. Some embodiments include additional technical effects, advantages, and/or improvements to computing systems and components.

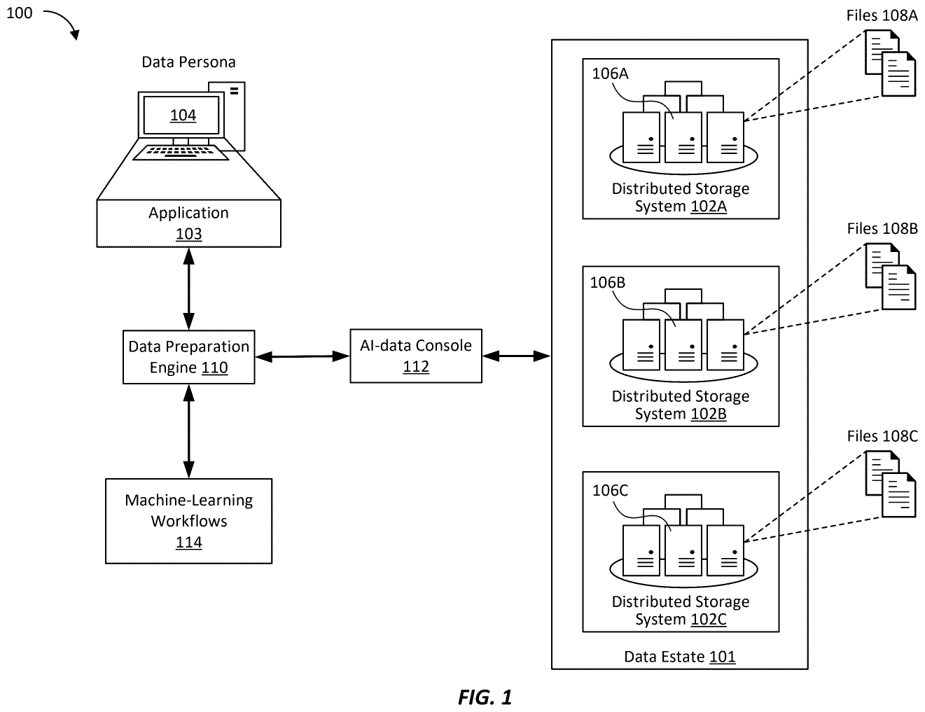

Turning now to the Figures, FIG. 1 illustrates an example operational environment for a system 100 for providing a data preparation engine 110 to a client device 104, according to an embodiment herein. As shown, a data persona, via the client device 104 may utilize an application 103 to curate a data collection for a downstream application, such as one or more machine-learning (ML) workflows 114. In particular, the data persona may search and retrieve data from an organization's extensive data estate 101 for use within one or more data collections using the data preparation engine 110. As illustrated, the data estate 101 may include multiple distributed storage systems 102A-C, which may include on-premises servers 106A-C, cloud-based platforms 106A-C, or hybrid systems 106A-C that combine both on-premises and cloud environments. Each of these storage systems 102A-C holds various data stores, including numerous files 108A-C, which contain the organization's vast array of structured and unstructured data. It should be appreciated that while only three storage systems 102A-C are illustrated, a data estate 101 may include any number and combination of storage systems 102A-C.

As noted above, the data persona may retrieve one or more of the files 108A-C to curate a data collection for use in the downstream ML workflows 114. Data collections are often a foundation for a wide range of downstream applications and workflows, serving as initial assets for various analytical and operational processes. As such, it should be appreciated that while the following discussion focuses on the ML workflows 114, other downstream applications are contemplated herein. For instance, the ML workflows 114 may use the curated data collections to train and validate AI models, helping algorithms learn patterns and make predictions based on historical data. However, in business intelligence, data collections may support data-driven decision-making by providing insights through dashboards and reports. The data collections may also play a critical role in natural language processing (NLP), where they can be used to enhance models for text analysis, sentiment analysis, and language translation. Additionally, in research and development, well-organized data collections may enable rigorous testing and validation of new hypotheses or technologies. By effectively leveraging curated data collections, organizations can drive innovation, improve accuracy, and achieve better outcomes across a range of applications and workflows.

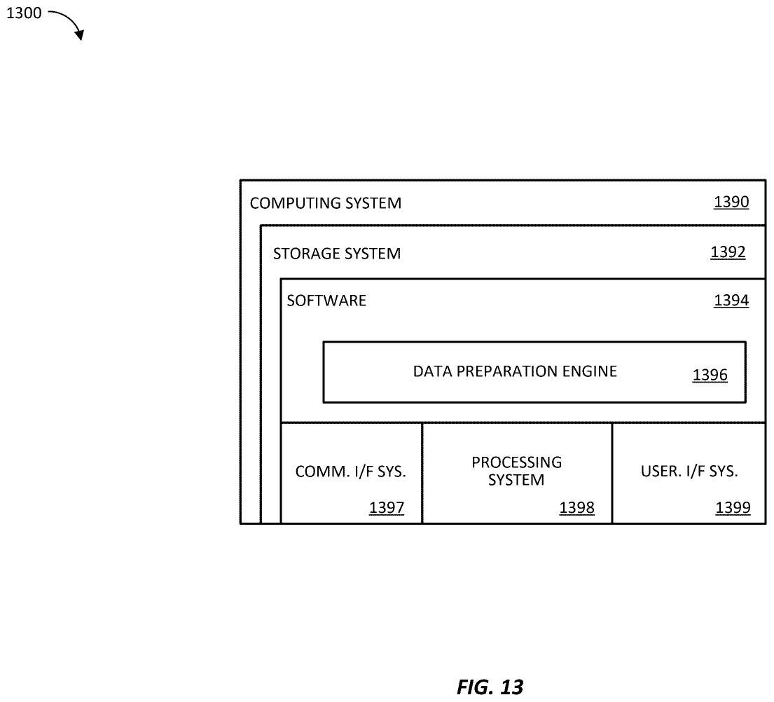

As illustrated, the client device 104 may communicate with the application 103 and/or the data preparation engine 110 via one or more internets and intranets, the Internet, wired and wireless networks, local area networks (LANs), wide area networks (WANs), or any other type of network or combination thereof. Examples of the client device 104 may include personal computers, tablet computers, mobile phones, gaming consoles, wearable devices, Internet of Things (IoT) devices, and any other suitable devices, of which computing apparatus 1390 in FIG. 13 is also broadly representative.

In some embodiments, when the data persona performs a search for data, the application 103 may interact with an AI-data console 112 to search for and retrieve data from the data estate 101. For example, the data preparation engine 110 may leverage the AI-data console's 112 advanced data management and analytic capabilities. When the search is initiated by the data persona, via the application 103, the data preparation engine 110 may interface with the AI-data console 112, which may serve as a unified control plane for the data estate 101 and provide a comprehensive view of the distributed storage systems 102A-C. When queries are submitted via the application 103, the data preparation engine 110 may coordinate with the AI-data console 112 to aggregate and index data housed across the storage systems 102A-C, including the files 108A-C and other data assets. In some embodiments, the AI-data console's 112 data discovery features may enable the data preparation engine 110 to quickly locate and access relevant information from these disparate sources.

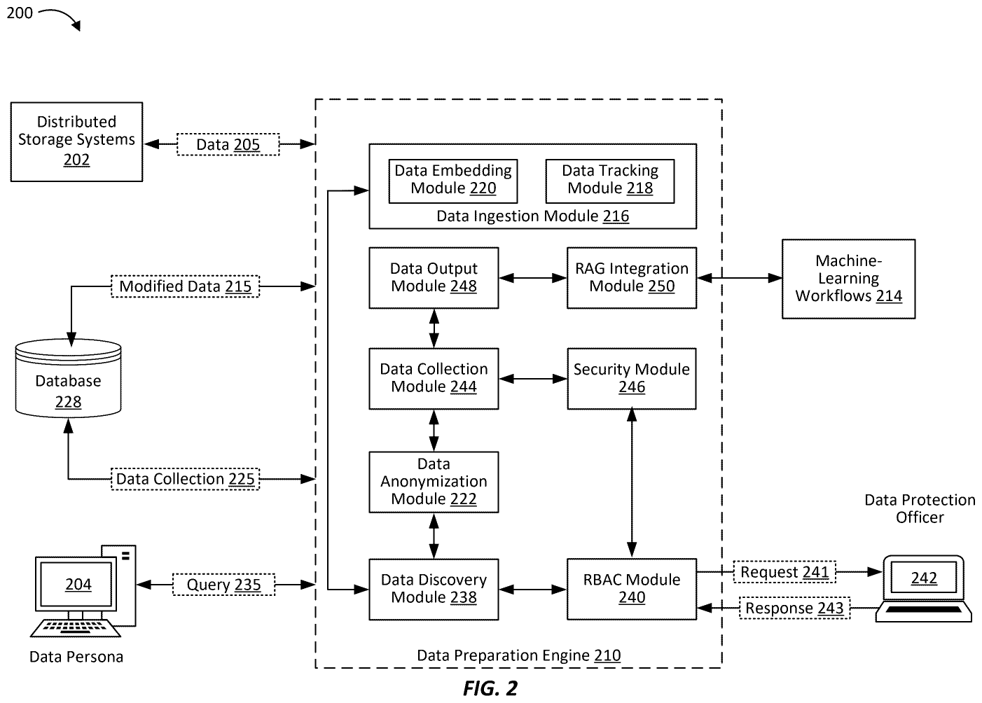

In some embodiments, the data preparation engine 110 may employ content-based classification techniques to index the files 108A-C rather than relying on traditional filename-based classification approaches. As described in greater detail below with respect to FIGS. 2-4, this content-based indexing approach may analyze the actual content, structure, and semantic meaning within each file 108A-C to determine its relevance and classification. The data preparation engine 110 may utilize advanced natural language processing, machine learning models, and semantic analysis to understand the contextual information contained within documents, regardless of how the files are named or organized within the distributed storage systems 102A-C.

Conventional indexing approaches that rely primarily on filename-based classification may suffer from limitations that can lead to misclassification and reduced search accuracy. Filenames are often opaque, non-descriptive, or may follow inconsistent naming conventions across different departments or storage systems within an organization's data estate 101. For example, a file named “report_final_v2.pdf” or “data_123456.xlsx” provides little indication of its actual content, subject matter, or relevance to specific queries. Additionally, files may be renamed, moved, or stored with automatically generated filenames that bear no relationship to their content. By implementing content-based classification, the data preparation engine 110 may overcome these limitations and provide more accurate data discovery capabilities, ensuring that relevant files 108A-C are identified based on their actual informational value rather than potentially misleading or uninformative filename attributes.

The AI-data console 112 may leverage the content-based classification capabilities of the data preparation engine 110 to identify relevant or applicable files 108A-C for integration into a respective data collection. By utilizing the semantic understanding and contextual analysis provided by the content-based indexing approach, the AI-data console 112 may more effectively match files to specific data collection criteria, regardless of filename conventions or storage location hierarchies. This integration may enable the AI-data console 112 to present data personas with more accurate and contextually relevant file recommendations, improving the efficiency and quality of data collection curation processes across the distributed storage systems 102A-C.

Once data is retrieved, or as described below as ingested by the data preparation engine 110, the data preparation engine 110 may identify data containing sensitive information. As used herein, sensitive information may include data that requires protection due to its confidential nature or its potential to cause harm if disclosed. This includes, but is not limited to, PII such as names, addresses, Social Security numbers, and financial details; health information protected under regulations like the HIPAA; and proprietary business information such as trade secrets and intellectual property. Sensitive data also encompasses information that may be subject to specific regulatory and governing policies, such as GDPR in the European Union, which mandates stringent controls over data relating to individuals' privacy and rights, or the CCPA, which provides similar protections within California. These policies impose strict requirements on how sensitive information must be handled, stored, and shared to prevent unauthorized access and ensure compliance with legal and ethical standards. As such, the data preparation engine 110 may implement security measures, as described in greater detail below, to sanitize sensitive information, monitor access to the sensitive data, and ensure compliance with applicable policies as the respective data is prepared for use in one or more data collections.

Once sensitive information is identified, the data preparation engine 110 may sanitize or anonymize the sensitive information. That is, the data preparation engine 110 may perform one or more data sanitization processes to protect the confidentiality of the data while preserving the utility and context of the underlying data, thereby generating sanitized files. For example, the data preparation engine 110 may remove or alter sensitive elements within one or more of the files 108A-C, such as masking or encrypting personal identifiers, so that the data cannot be traced back to individuals. In some cases, the data preparation engine 110 may anonymize one or more of the files 108A-C such to modify the data in a way that prevents identification of individuals, such as aggregating data points or replacing specific details with generalized information. Importantly, throughout the sanitization/anonymization processes, the data preparation engine 110 may maintain the context and integrity of the information, ensuring that the data remains meaningful and useful for the downstream processes (e.g., workflows 114).

As will be described in greater detail below, the data preparation engine 110 may provide one or more of the files 108A-C that it identifies as relevant to the data persona's search. From these files 108A-C, the data persona may select which of the files to include in a data collection. Once a data collection is completed, the data preparation engine 110 may prepare the data collection in a desired and secure format and provide a secure method for exporting the data collection to the downstream workflows 114. For example, the data preparation engine 110 may deploy the data collection for use within an AI cluster (e.g., a specialized, self-contained unit or environment designed to run artificial intelligence applications and processes) or provide access information (e.g., authentication token) via an application programming interface (API) to the data collection.

In example embodiments, the data collection may be used to generate training data sets for one or more AI-based systems, such as a multi-modal generative model, a chatbot application, a natural language processing system, or a computer vision model. These training data sets, curated and sanitized by the data preparation engine 110, provide high-quality inputs that maintain data integrity while protecting sensitive information. The data preparation engine 110 may prepare the data collection in a desired and secure format and provide a secure method for exporting the data collection to the downstream workflows 114. For example, the data preparation engine 110 may deploy the data collection for use within an AI cluster (e.g., a specialized, self-contained unit or environment designed to run artificial intelligence applications and processes) or provide access information (e.g., authentication token) via an application programming interface (API) to the data collection.

Once the data collection is deployed, the data preparation engine 110 may continue to automatically and continuously monitor and track the files 108A-C incorporated within the respective collection, as well as the entire data estate 101 for new files that may be applicable to the collection. For example, the data preparation engine 110 may detect changes made to the source data within the data estate 101 and monitor for any security issues, such as suspected data poisoning. Additionally, as new files are added to the data estate 101 that match the criteria of existing data collections, the data preparation engine 110 may automatically update these collections in real-time, classifying the new files, sanitizing any sensitive information they contain, and indexing them for immediate integration. This real-time updating capability ensures that downstream applications always have access to the most comprehensive and compliant data available, without requiring manual intervention from the data persona for each new file addition.

Moreover, this updating process ensures that the machine-learning workflows 114 are operating or integrating up-to-date data, thereby ensuring accuracy and reliability of the analytical outputs and maintaining compliance with evolving regulatory requirements. The data preparation engine 110 continuously monitors for changes to ensure that any modifications to source data are properly vetted, sanitized, and incorporated into existing data collections without compromising data integrity or security protocols. Tracking and monitoring of files 108A-C incorporated into a data collection are described in greater detail below with respect to FIGS. 2-12.

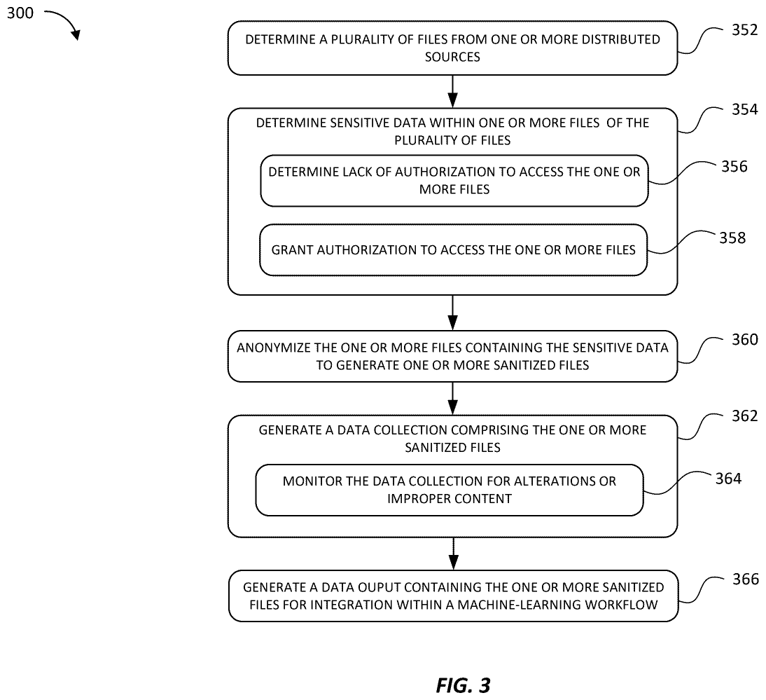

Turning now to FIG. 2, an example system 200 in which a data persona curates a data collection 225 using a data preparation engine 210 is illustrated, according to an embodiment herein. For case of illustration, FIG. 2 is described with reference to FIG. 3. FIG. 3 provides a process 300 for providing a data preparation engine 210, according to an embodiment herein. While the process 300, which may be referred to herein as a data preparation process, is described with respect to FIG. 2, it should be appreciated that it is equally applicable to other systems and components provided herein. Additionally, while the process 300 illustrates steps 352-366, the process 300 is not limited to these steps and may include additional steps or may lack one or more of these steps. That is, the steps 356-366 are provided to illustrate the data preparation process, not limit it to these steps.

As shown, the data persona may submit a query 235 to perform data discovery for curation of the data collection 225. The query 235 may be submitted via the client device 204, which may be the same or similar to the client device 104, to the data preparation engine 210, which may be the same or similar to the data preparation engine 210. Responsive to receiving the query 235, the data preparation engine 210 may determine data 205 containing relevant information to the query 235 (352). For example, the data preparation engine 210 may identify multiple files or documents from distributed storage systems 202 containing content relevant to the query 235, such as via the platform 112 described above. The distributed storage systems 202 may be or include one or more of the distributed storage systems 102A-C within a respective organizations data estate 101.

To identify the data 205 relevant to the query 235, the data preparation engine 210 may include a data ingestion module 216. The data ingestion module 216 may provide efficient access to data 205 from various distributed storage systems 202. The data ingestion module 216 may quickly and effectively retrieve and display data from the multiple distributed storage systems 202 (e.g., cloud storage, databases, or other data repositories) into a unified interface provided by the data preparation engine 210, such as via a user interface on the client device 204. As such, once data is ingested, the data preparation engine 210 may function as a tool that allows users to browse, query, and analyze the data 205.

In some embodiments, the data ingestion module 216 includes a data embedding module 220 and/or a data tracking module 218. The data embedding module 220 may ingest data 205 as an initial process and then the data tracking module 218 may detect any changes to the data 205 at the source and incorporate those changes into the data collection 225. Each of these processes is described in greater detail below.

In some embodiments, as part of the ingestion process, the data preparation engine 210 may index the data 205 (or modified data 215) using content-based classification techniques that analyze the actual content, structure, and semantic meaning within each file. This content-based indexing approach leverages advanced natural language processing, machine learning models, and semantic analysis to understand the contextual information contained within documents, regardless of how the files are named or organized within the distributed storage systems 202. By examining the semantic relationships, key concepts, and contextual relevance of the content itself, the data preparation engine 210 can more accurately categorize and retrieve files based on their informational value rather than superficial attributes. The content-based classification approach enables more precise identification of relevant files for data collections, as it focuses on what information the files actually contain rather than relying on potentially misleading metadata.

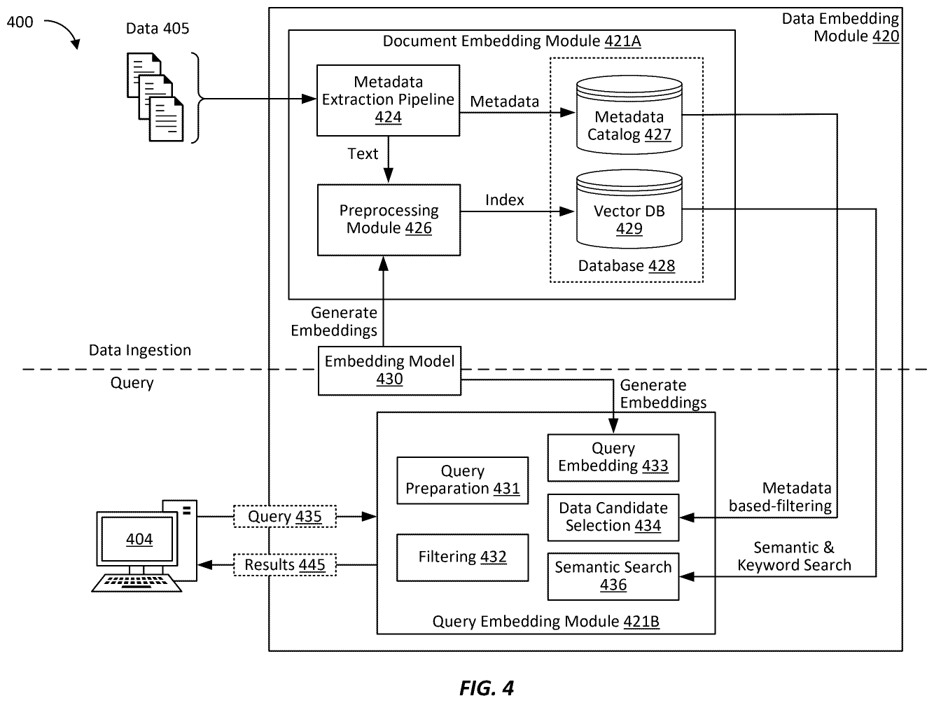

Referring now to FIG. 4, a detailed view 400 of an example data embedding module 420, which may be the same or similar to the data embedding module 220, is illustrated, according to an embodiment herein. In particular, the detailed view 400 illustrates an example embedding process for the data ingestion processes, as well as an embedding process for the query 235/435 as it is received from a data persona, each of which is described in turn in the following. For case of explanation, FIG. 4 is described in relation to FIG. 2 so the following description may refer to both figures in tandem.

As illustrated, the data embedding module 420 processes source data 405, which may be the same as data 205, through a series of specialized components to enable efficient discovery, classification, and retrieval of relevant information. For example, the data embedding module 420 includes a document embedding module 421A that processes incoming data 405 through multiple stages. Initially, the data 405 is processed by a metadata extraction pipeline 424 that systematically extracts structured metadata from the files, including file attributes, creation dates, author information, and document properties. This extracted metadata is then cataloged and stored in a metadata catalog 427 within the database 428, creating a searchable index of document attributes that facilitates efficient filtering and retrieval operations. Simultaneously, the metadata extraction pipeline 424 extracts textual content from the data 405 using format-specific parsers that can process various file types including PDFs, office documents, plain text, and structured data formats.

The extracted text is then passed to a preprocessing module 426 that performs several operations. First, the text undergoes normalization procedures including tokenization, stemming, and removal of stop words to standardize the content for analysis. Next, the preprocessing module 426 performs content-based classification by analyzing the semantic structure, key concepts, and contextual relationships within the text. This classification process may leverage natural language processing techniques to categorize documents based on their actual informational content rather than superficial metadata. The preprocessing module 426 then generates dense vector representations (e.g., embeddings) of the documents that capture their semantic meaning in a high-dimensional space, enabling similarity comparisons based on content rather than keywords alone.

The generated embeddings are stored in a vector database 429 within the database 428, which may be configured for high-dimensional vector operations and similarity searches. The vector database 429 may implement specialized indexing structures such as hierarchical navigable small world (HNSW) graphs or inverted file indexes with product quantization (IVF-PQ) to enable efficient approximate nearest neighbor searches across millions of document embeddings. This architecture allows for sub-second query response times even when searching across large document collections.

As illustrated, the data embedding module 420 may include one or more embedding models 430 that play a role in both document processing and query handling. The embedding models 430 may include transformer-based architectures such as BERT, ROBERTa, or domain-specific models fine-tuned on relevant corpora. In some implementations, the data embedding module 420 may employ multiple embedding models 430 specialized for different content types or domains, with an ensemble approach that combines their outputs for improved accuracy. For example, the data embedding models 430 may include a semantic search based embedding models, while in other embodiments, the data embedding models 430 may operate on screenshots of the respective data 405 (e.g., documents). In such cases, since embeddings on images typically are within the same latent space as semantic search query embeddings, such embedding models can result in higher search performance.

In some cases, the embedding models 430 transform the preprocessed text into fixed-length vector representations that capture the semantic relationships between words, phrases, and concepts in the document. These dense representations (e.g., embeddings) enable the data preparation engine 210 to understand the contextual meaning of content beyond simple keyword matching, allowing for more nuanced and accurate retrieval of relevant information when responding to user queries.

With reference to FIG. 2, in addition to ingesting the data 205, the data ingestion module 216 may also include the data tracking module 218. The data tracking module 218 may detect and transfer real-time data changes to the data 205 from the distributed storage system 202 to the database 228. For example, the data tracking module 218 may implement a continuous monitoring protocol that utilizes checksums, timestamp comparisons, and content-based hashing algorithms to identify modifications to existing files or the addition of new files within the distributed storage systems 202. The data tracking module 218 may employ differential analysis techniques, such as Snapdiff technology, to efficiently identify only the changed portions of files rather than reprocessing entire documents.

When changes are detected, the data tracking module 218 may generate a change manifest that catalogs the specific modifications, including metadata alterations, content changes, and structural differences between versions. This change manifest is then passed to the data embedding module 220/420, which selectively reprocesses only the modified content through its embedding pipeline, thereby optimizing computational resources while maintaining up-to-date representations of the data estate within the database 228. The data tracking module 218 may also implement priority-based processing to ensure that high-impact changes, such as those affecting sensitive information or compliance-related content, are processed with higher precedence than routine modifications.

When queries are received from the client device 404, the data embedding module 420 processes them through a query embedding module 421B that works in coordination with the document processing components to identify relevant information. The query 435, which may be the same as the query 235, is initially received by the query embedding module 421B and processed through several specialized components that work together to match the query against the indexed data.

The query preparation module 431 serves as the initial processing stage for incoming queries, performing normalization and preprocessing operations on the raw query text. The query preparation module 431 may apply text cleaning procedures including removal of special characters, standardization of whitespace, and conversion to lowercase to ensure consistency with the document processing pipeline. In some embodiments, the query preparation module 431 may also perform query expansion techniques, such as adding synonyms or related terms, to improve retrieval accuracy. The query preparation module 431 may implement spell correction algorithms to handle typographical errors in user queries and may apply stemming or lemmatization to reduce words to their root forms, ensuring that variations of the same concept can be matched effectively.

The filtering module 432 applies initial constraints and filters to narrow the search space before performing computationally intensive similarity calculations. The filtering module 432 may implement various filtering strategies including date range filters, file type restrictions, source system constraints, and access permission checks based on the user's authorization level. In some cases, the filtering module 432 may apply metadata-based filters that exclude documents that do not meet basic criteria specified in the query, such as documents from specific departments, projects, or compliance categories. The filtering module 432 may also implement performance optimization techniques by pre-filtering the document corpus to reduce the number of embeddings that need to be compared during the semantic search process.

The query embedding module 433 leverages the embedding models 430 to transform the preprocessed query into a dense vector representation that can be compared against the document embeddings stored in the vector database 429. The query embedding module 433 may utilize the same embedding models 430 that were used during document processing to ensure consistency in the vector space representation. In some implementations, the query embedding module 433 may apply different embedding strategies for different types of queries, such as using specialized models for technical queries versus general business queries. The query embedding module 433 may also implement query contextualization techniques that consider the user's role, previous queries, or current project context to generate more targeted embeddings.

The data candidate selection module 434 performs metadata-based filtering operations on the metadata catalog 427 to identify a subset of potentially relevant documents before conducting semantic similarity searches. The data candidate selection module 434 may implement efficient indexing and filtering algorithms that can quickly eliminate documents that do not match basic query criteria, such as file format requirements, creation date ranges, or author specifications. In some embodiments, the data candidate selection module 434 may use inverted indexes or hash-based lookup structures to rapidly identify candidate documents based on metadata attributes. The data candidate selection module 434 may also implement ranking algorithms that prioritize documents based on metadata relevance scores, ensuring that the most promising candidates are processed first during the semantic search phase.

The semantic search module 436 operates in communication with the vector database 429 to perform similarity calculations between the query embedding and the document embeddings. The semantic search module 436 may implement approximate nearest neighbor search algorithms, such as locality-sensitive hashing or tree-based indexing structures, to efficiently identify the most semantically similar documents to the query. In some cases, the semantic search module 436 may employ multiple similarity metrics, including cosine similarity, Euclidean distance, or dot product calculations, to rank documents based on their relevance to the query. The semantic search module 436 may also implement result fusion techniques that combine semantic similarity scores with metadata-based relevance scores to produce a final ranking of search results. Additionally, the semantic search module 436 may apply post-processing filters to ensure that returned results meet quality thresholds and comply with access control policies before presenting them to the user through the search results 445. As noted above, the results 445 may include documents that match the query 435/235, and may be presented via a user interface to the data persona.

With reference to FIG. 2, after the semantic search module 436 identifies relevant files based on the query 435, the data preparation engine 210 stores the retrieved data 205 as modified data 215 in a database 228 for further processing. The database 228 may be structured similarly to database 428, incorporating both traditional database functionality and vector storage capabilities to efficiently manage the modified data 215. By maintaining the modified data 215 in the database 228, the data preparation engine 210 creates a working copy of the relevant information without altering the original data 205 within the distributed storage system 202, allowing for subsequent processing operations while preserving data integrity.

Following the embedding and retrieval processes described above, a data discovery module 238 examines the modified data 215 stored within the database 228 to identify sensitive information (354). The data discovery module 238 analyzes the content and context captured in the document embeddings generated by the embedding models 430 to detect sensitive content. This identification process employs a combination of pattern recognition algorithms, natural language processing techniques, and specialized machine learning models trained to identify various categories of sensitive data such as personally identifiable information (PII), protected health information (PHI), and proprietary business information. The data discovery module 238 may also utilize metadata analysis to examine document properties, classifications, and contextual relationships between data elements. The semantic understanding capabilities established during the embedding process enable the data discovery module 238 to recognize sensitive information even when it appears in non-standard formats, ambiguous contexts, or across heterogeneous document types within the distributed storage systems.

The data discovery module 238 may be in operable communication with a data anonymization module 222. As such, responsive to identifying sensitive information, the data discovery module 238 may coordinate with the data anonymization module 222 to sanitize or anonymize the sensitive information (360), and in some cases generate one or more sanitized files. In some cases, the data anonymization module 222 may sanitize/anonymize the sensitive information prior to one or more of steps (354), (356), and/or (358). To anonymize or sanitize the sensitive data, the data anonymization module 222 may perform one or more anonymization processes, such as masking, tokenization, generalization, perturbation, and/or synthetic data generation to protect the sensitive data.

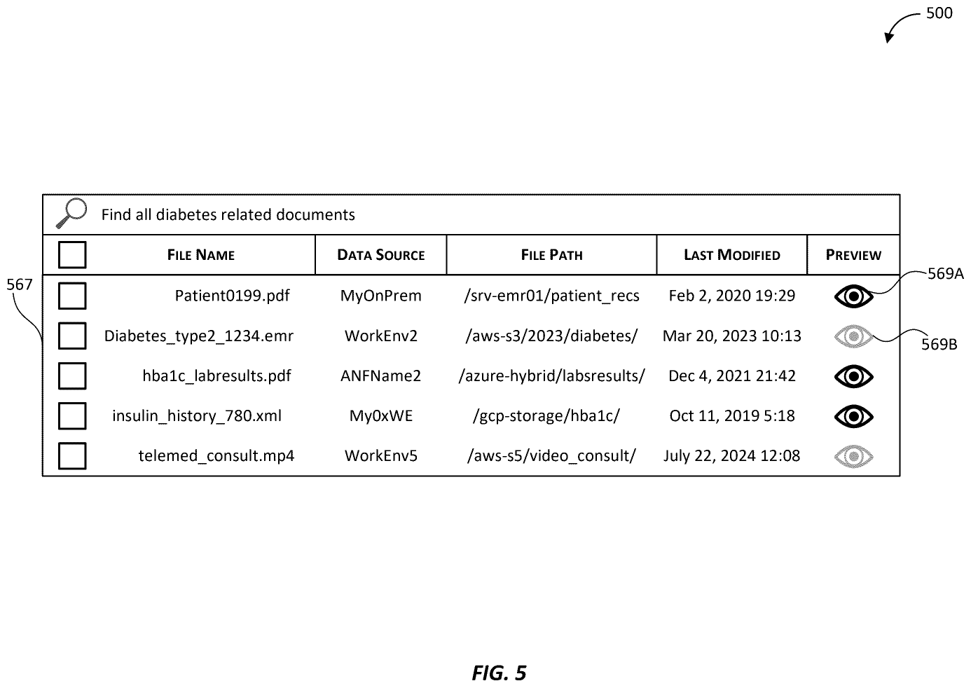

FIG. 5 illustrates an example search interface 500 for providing files identified by the data preparation engine as relevant to a query, according to an embodiment herein. The search interface 500 displays a file listing 567 containing multiple document entries with associated metadata such as file names, data sources, file paths, and last modified dates. The interface includes preview icons 569A that indicate files available for preview, while restricted preview icons 569B denote files with limited access permissions that require additional authorization. The search interface 500 enables data personas to browse and select relevant files for inclusion in a data collection while providing visual indicators of access restrictions.

In addition to providing search capabilities, the data preparation engine 210 includes a security module 246 that identifies sensitive information subject to applicable governing policies, such as regulatory requirements. When anonymizing sensitive data to generate sanitized files, the data preparation engine 210 provides compliance status indicators for these files.

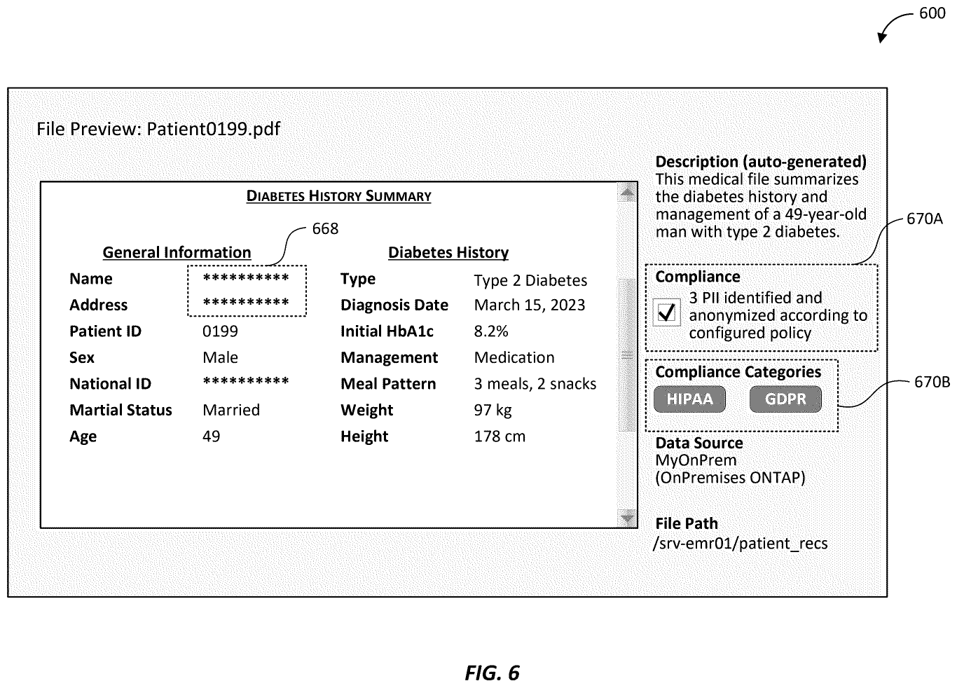

With reference to FIG. 6, an example medical file interface 600 showing a sanitized file generated by the data preparation engine 210 is illustrated, according to an embodiment herein. That is, the data preparation engine 210 anonymized the sensitive information within the illustrated file. The interface 600 includes a general information section containing patient medical details with sensitive information anonymized 668. The interface 600 also displays compliance status indicator 670A showing the file has been properly anonymized according to configured policies, while compliance category indicators 670B show applicable regulatory frameworks such as HIPAA and GDPR that govern the sensitive data within the file. In some cases, the data preparation engine 210 typically generates a summary or brief description of the compliance status for each file, allowing data personas to quickly review the regulatory standing of files they wish to include in their data collections.

As noted above, the data discovery module 238 may identify the data 205 or modified data 215 that is relevant to the query 235. Responsive to identifying relevant modified data 215, the data preparation engine 210 may provide the results including the relevant files to the client device 204. In some cases, however, the data preparation engine 210 may identify files or data that the data persona does not have authorization to view or access, as indicated by the icon 569B from FIG. 5 (356). To allow the data persona access to a respective secure file, such as the files indicated by the icon 569B, the data preparation engine 210 may include a Role-Based Access Control (RBAC) module 240. The RBAC module may be managed by a data protection officer (DPO) via a client device 242 to ensure secure access to the data 205/215 and the data collection 225. That is, the DPO may define and manage roles, permissions, and grant authorization to data personas for accessing the data collections 225 and underlying data. As can be appreciated, the DPO may ensure that only authorized users can access specific data collections 225, and thus underlying data 215, based on their roles.

In some embodiments, the RBAC module 240 may identify access permission requirements applicable to a respective secure file, in some cases based on the content-based classification of the file, and implement applicable access-controls to the file based on the access permission requirements. The RBAC module 240 may analyze the semantic content and contextual information within each file to determine appropriate security classifications and corresponding access restrictions. For example, files containing financial data may be classified with higher security requirements than general business documents, while files containing personally identifiable information may trigger specific regulatory compliance controls. The RBAC module 240 may coordinate with the security module 246 to establish granular permissions that restrict access based on user roles, departmental affiliations, and clearance levels. In some cases, the RBAC module 240 may implement multi-layered access controls where users may have different permission levels for viewing, editing, or exporting data depending on their assigned roles and the sensitivity classification of the underlying content.

The RBAC module 240 may further implement attribute-based access control (ABAC) capabilities that evaluate access permissions based on a combination of user attributes, resource attributes, and environmental conditions. This approach enables more contextual and fine-grained access decisions that can adapt to changing circumstances. For instance, the RBAC module 240 may restrict access to certain files based on the user's geographic location, time of access, device security posture, or authentication method strength. Additionally, the RBAC module 240 maintains comprehensive audit logs of all access attempts, permission changes, and file interactions, creating an immutable record for compliance verification and security forensics. These logs capture detailed information including the identity of users requesting access, timestamps of access events, specific files accessed, and actions performed on those files, thereby providing complete visibility into data access patterns across the organization.

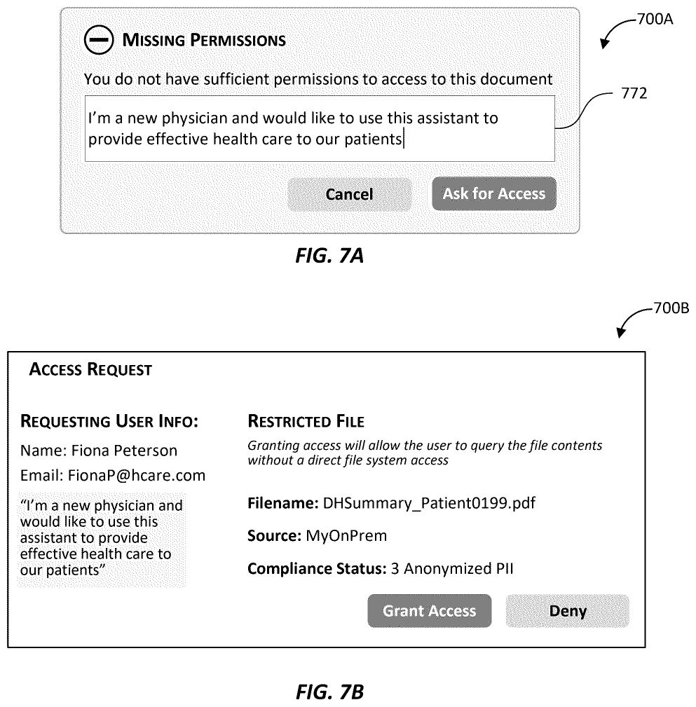

In some embodiments, such as the above example, the data persona does not have authorization to access the files corresponding to the icons 669B, the data persona can submit a request for access. FIG. 7A illustrates an example missing permissions dialog 700 for requesting access to a secured file, according to an embodiment herein. Here, an access request message 772 indicates that the data persona is a new physician attempting to access a file but does not have permission. The access request message 772 may be transmitted by the data preparation engine 210 to the DPO via a request 241 to the client device 242.

FIG. 7B illustrates an example access request interface 700B, which may be the same or similar to the request 241, for accessing a secure file, according to an embodiment herein. The DPO may receive the access request interface 700B and grant access or deny access to the data person for accessing the respective data/file (358), such as via a response 243 received by the data preparation engine 210 from the protection officer device 242. As illustrated, the access request interface 700B may include information on the requesting user, the restricted file, and provide an indication of the compliance status.

Beyond managing legitimate access requests, the data preparation engine 210 may implement multiple layers of security measures to safeguard against data exfiltration and unauthorized data access. In some embodiments, the data preparation engine 210 may employ data loss prevention (DLP) techniques that monitor and control data movement both within the system and to external destinations. The security module 246 may continuously scan outbound data transfers and API calls to detect suspicious patterns or unauthorized attempts to extract large volumes of sensitive information. Additionally, the data preparation engine 210 may implement watermarking or digital fingerprinting techniques on processed data collections, allowing the system to trace and identify the source of any data that may be improperly accessed or distributed outside the authorized workflows.

The RBAC module 240 may further enhance data exfiltration protection by implementing granular access controls and audit logging capabilities, as described in greater detail below. In some cases, the data preparation engine 210 may establish data access quotas and rate limiting mechanisms that prevent users from downloading or accessing unusually large amounts of data within specified time periods. The system may also employ behavioral analytics to identify anomalous user activities, such as accessing files outside normal working hours or requesting access to data collections unrelated to a user's typical responsibilities. When suspicious activities are detected, the data preparation engine 210 may automatically trigger alerts to the DPO via the protection officer device 242 and may temporarily restrict the user's access privileges pending further investigation, thereby providing proactive protection against potential data exfiltration attempts.

The data preparation engine 210 may include a data collection module 244 for generating or curating a data collection, such as the data collection 225 (362). That is, the data collection module 244 may allow the data persona to create new data collections from discovered data, such as the modified data 215 identified by the data discovery module 238 responsive to the query 235. As described above, the modified data 215 may include sanitized or anonymized data. The data collection module 244 may include a variety of tools for organizing and managing data collections for use within downstream applications, such as the ML workflows 214, which may be the same or similar to the workflows 114.

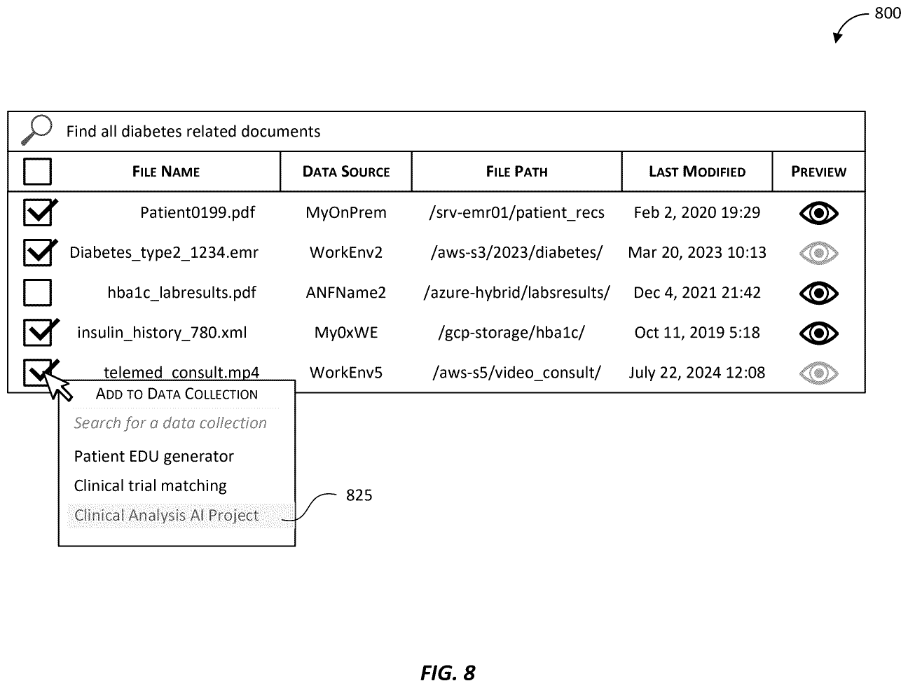

With reference to FIG. 8, an example GUI 800 illustrating the data persona selecting a subset of the files provided via the GUI 500 to use within the data collection 825, is illustrated, according to an embodiment herein. The GUI 800 shows file names, data sources, file paths, last modified dates, and preview options for each document. Several files are selected with checkboxes, indicating the data persona's selection of a subset of files to be included in the data collection 825, which may be the same or similar to the data collection 225. The GUI 800 includes a data collection menu 825 at the bottom of the interface with options including “Patient EDU generator,” “Clinical trial matching,” and “Clinical Analysis AI Project,” allowing the data persona to specify which collection 825 should receive the selected files. Upon selection, the files may be added to the data collection 825, enabling the data persona to curate specific content for downstream applications.

With reference to FIG. 2, once the data collection 225 is curated, the data preparation engine 210 may include a data output module 248 that generates a data output based on the data collection 225. The data output module 248 prepares the data collection 225 in a desired format for integration into downstream applications, such as the machine learning workflows 214. For example, the data output module 248 may generate a training data set for an AI-based system, such as a multi-modal generative model, a chatbot application, a natural language processing system, or a computer vision model. These training data sets, curated and sanitized by the data preparation engine 210, provide high-quality inputs that maintain data integrity while protecting sensitive information. The data output module 248 may save the dataset in various formats and provide secure methods for exporting the data collection 225 to the workflows 214, such as deploying the collection to an AI cluster or providing access information via an API.

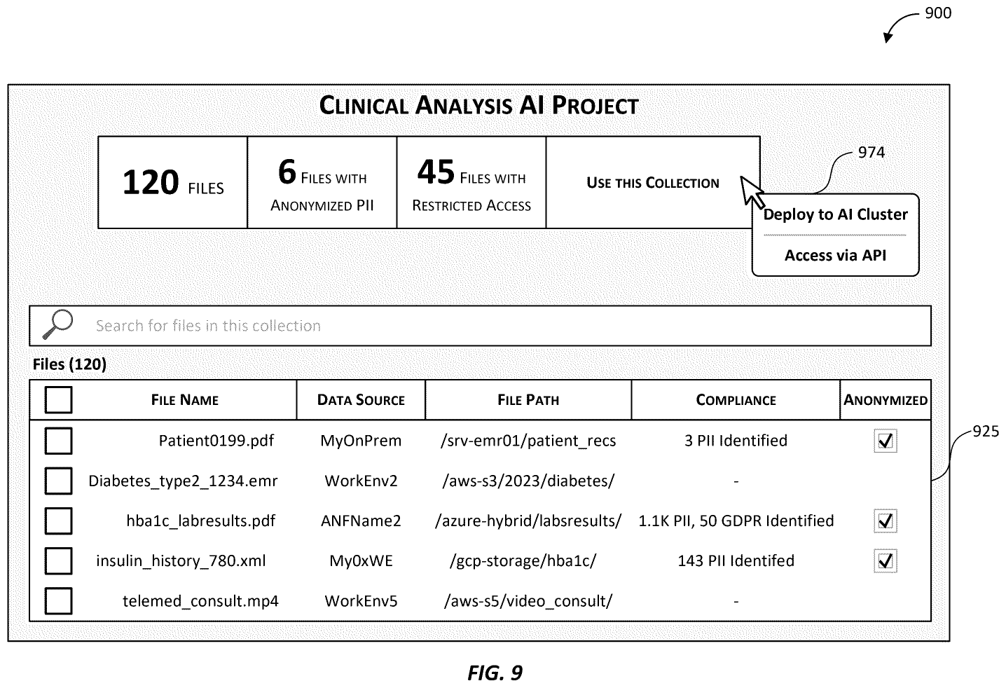

Referring now to FIG. 9, an example GUI 900 illustrates how a data persona may view and manage a data collection 925 is illustrated, according to embodiments herein. As shown, the GUI 900 provides the data persona with comprehensive information about the underlying data within the data collection 925, which may be the same or similar to the data collection 225. The information provided may include metrics such as the total file count (120), the number of files containing anonymized personally identifiable information (6), and files with restricted access (45). The GUI 900 also presents deployment options 974 that allow the data persona to integrate the data collection into downstream applications. Through these options, the data persona can choose to deploy the collection directly to an AI cluster for immediate use in machine learning workflows, or alternatively, obtain API access information that enables programmatic interaction with the data collection from external applications and systems.

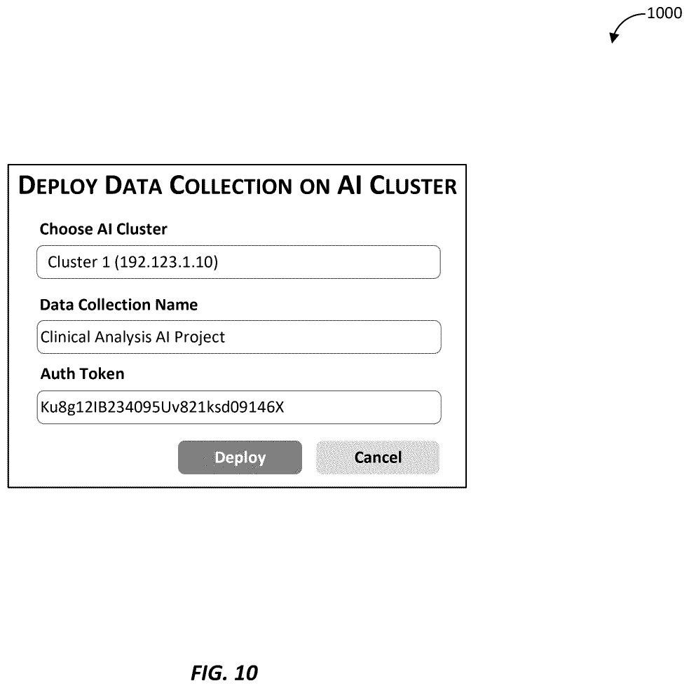

As noted above, in some embodiments, the data collection 925 may be deployed directly to an AI cluster. FIG. 10 illustrates an example prompt 1000 that may be provided to the client device 204 for deploying the data collection 925/225 on an AI cluster for integration into the workflows 214, according to an embodiment herein. The deployment prompt 1000 includes several input fields that allow the data persona to configure the deployment parameters, including a dropdown menu for selecting a specific AI pod with its associated IP address, a field displaying the name of the data collection to be deployed (shown as “Clinical Analysis AI Project”), and a secure authentication token field that provides the necessary credentials for accessing the deployed collection. The prompt 1000 includes “Deploy” and “Cancel” buttons at the bottom, allowing the data persona to either confirm the deployment operation or cancel it. By providing this deployment interface, the data preparation engine enables seamless integration of curated and sanitized data collections into downstream AI workflows while maintaining appropriate security controls through the authentication token mechanism.

The workflows 214, as used herein, may encompass a wide range of machine learning and AI applications that benefit from curated, sanitized datasets. In some embodiments, the data collection 225 may be utilized to generate training datasets for various AI models, including but not limited to natural language processing systems, computer vision models, predictive analytics engines, and multi-modal generative models.

The workflows 214 may also include data science pipelines for statistical analysis, business intelligence applications for generating insights and reports, and research and development processes that require high-quality, compliant datasets. In some cases, the data collection 225 may serve as input for automated machine learning (AutoML) platforms, where the curated data can be used to train, validate, and test multiple model architectures simultaneously. Additionally, the workflows 214 may incorporate the data collection 225 into real-time inference systems, chatbot applications, recommendation engines, or anomaly detection systems. The sanitized and anonymized nature of the data collection 225 ensures that these downstream workflows 214 can operate on high-quality data while maintaining compliance with regulatory requirements and protecting sensitive information, thereby enabling organizations to leverage their data assets for innovation and competitive advantage without compromising security or privacy standards.

In some embodiments, the data preparation engine 210 may include or be integrated with a retrieval-augmented generation (RAG) module 250 for integrating the data collection 225 into the workflows 214. For example, the RAG module 250 may integrate with Nvidia's NeMo RAG capabilities to enable conversational AI. That is, the RAG module 250 may connect the database 228 with the workflows 214 to store and retrieve embeddings as required during the RAG operation. This may facilitate the setup of chatbot applications by integrating endpoints and selecting relevant data collections 225 stored within the database 228. In other embodiments, the RAG module 250 may be utilized to enhance document analysis systems that automatically extract and classify information from complex technical documents, enabling advanced search capabilities that allow users to query document repositories using natural language and receive precise answers with source citations rather than just keyword matches.

After the data collection 225 is deployed or otherwise integrated into the downstream applications, the data preparation engine 210 may continue to monitor and track any changes to the modified data 215 within the data collection 225. The deployment process may involve several integration methods depending on the specific downstream workflow requirements. For machine learning workflows 214, the data collection 225 may be deployed directly to an AI cluster where it serves as training data for model development. Alternatively, the data preparation engine 210 may establish secure API endpoints that allow downstream applications to access the data collection 225 programmatically while maintaining all security and compliance controls. In some implementations, the data preparation engine 210 may generate specialized data formats optimized for specific AI frameworks, such as TensorFlow or PyTorch, ensuring that the sanitized data is immediately usable within these environments without requiring additional preprocessing steps.

Once deployed, the data tracking module 218 continuously monitors the source data 205 within the distributed storage systems 202 for any modifications, additions, or deletions. This monitoring occurs in real-time through various mechanisms, including file system event listeners, database change data capture (CDC) processes, and periodic differential analysis of content hashes. When changes are detected in the source data 205, the data tracking module 218 immediately captures these changes and updates the modified data 215 in the database 228. The data tracking module 218 maintains a comprehensive change log that records all modifications, including the specific files affected, the nature of the changes, timestamps, and the user or process responsible for the change.

The data tracking module 218 employs sophisticated differential analysis techniques to efficiently identify only the changed portions of files rather than reprocessing entire documents. This approach significantly reduces computational overhead and enables near real-time updates to the data collection 225. When new files are added to the distributed storage systems 202 that match the criteria of existing data collections, the data preparation engine 210 automatically processes these files through the same rigorous identification and anonymization protocols applied to the original dataset. This ensures that all new content maintains the same level of compliance and security as the existing data collection.

If sensitive information is detected in newly added or modified files, the data anonymization module 222 automatically sanitizes this content according to the established policies before incorporating it into the data collection 225. Similarly, if files within the data collection 225 are modified at their source in ways that introduce new sensitive information, the data preparation engine 210 detects these changes and applies appropriate anonymization techniques to maintain compliance. The system also handles scenarios where source files referenced in the data collection 225 are deleted or moved, providing options to either remove these references from the collection or maintain archived versions to preserve the collection's integrity.

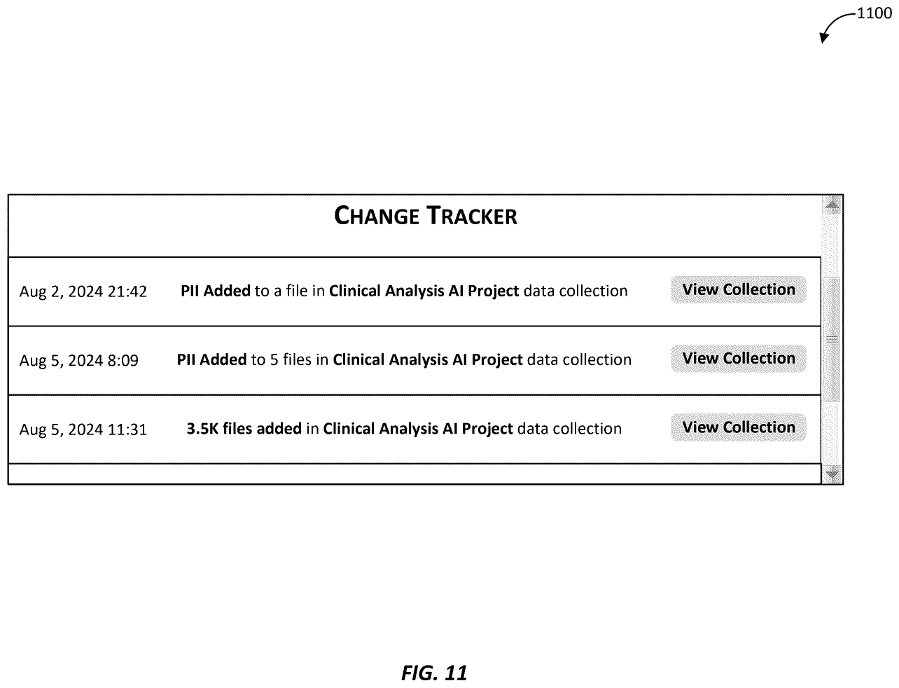

For example, the data tracking module 218 may use or include Snapdiff technology to efficiently identify and process only the changed portions of files. FIG. 11 illustrates an example prompt 1100 providing changes detected by the data tracking module 218 within the data 205, according to an embodiment herein. The prompt 1100 notifies the data persona of specific changes that may affect the data collection 225, such as the addition of new files containing relevant information, modifications to existing files that are part of the collection, or the introduction of new sensitive information that requires anonymization. This real-time notification system ensures that data personas remain aware of how their data collections evolve over time and can take appropriate actions to maintain the quality and compliance of their datasets.

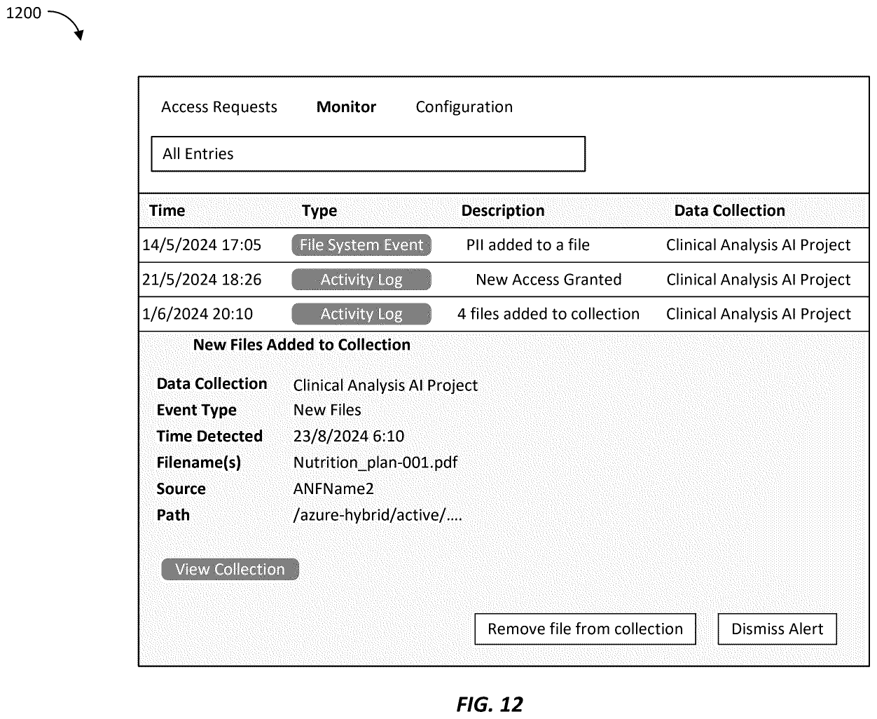

Referring now to FIG. 12, an example GUI 1200 identifying changes made to the data collection 225 is illustrated, according to an embodiment herein. As shown, the GUI 1200 may identify changes to data underlying the data collection 225, such as the addition of new files to the data collection 225, modifications to existing files, and whether or not PII is added to any files within the data collection 225. The data tracking module 218 continuously monitors the source data 205 and can detect when new content is added to the distributed storage systems 202 that may be relevant to an existing data collection 225.

When new files are detected that match the criteria of an existing data collection 225, the data preparation engine 210 can automatically flag these files for review. The GUI 1200 provides a comprehensive view of all changes, including timestamps indicating when each change was detected, the nature of the change (e.g., file addition, content modification), and the specific files affected. This monitoring capability ensures that data collections remain current and complete as new information becomes available in the distributed storage systems 202. Additionally, the data preparation engine 210 can be configured to send notifications to the DPO when significant changes are detected, allowing for timely review and incorporation of new content into the data collection 225 as appropriate.

Referring now to FIG. 13, is a diagram of a system 1300 configured to implement one or more steps for providing a data preparation engine as described herein, according to an embodiment. The system 1300 may be an example of an apparatus including a computing apparatus 1390 that is representative of any system or collection of systems in which the various processes, systems, programs, services, and scenarios disclosed herein may be implemented. For example, computing apparatus 1390 may be an example client device, such as the client device 104, or any of the subcomponents depicted in systems 100 or 200 of FIGS. 1 and 2, respectively. Examples of computing apparatus 1390 include, but are not limited to, server computers, desktop computers, laptop computers, routers, switches, web servers, cloud computing platforms, and data center equipment, as well as any other type of physical or virtual server machine, physical or virtual router, container, and any variation or combination thereof.

Computing apparatus 1390 may be implemented as a single apparatus, system, or device or may be implemented in a distributed manner as multiple apparatuses, systems, or devices. Computing apparatus 1390 may include, but is not limited to, processing system 1398, storage system 1392, software 1394, communication interface system 1397, and user interface system 1399. Processing system 1398 may be operatively coupled with storage system 1392, communication interface system 1397, and user interface system 1399.

Processing system 1398 may load and execute software 1394 from storage system 1392. Software 1394 may include data preparation engine process 1396, which may be representative of one or more steps of the data preparation process, as discussed with respect to the preceding figures. When executed by processing system 1398, software 1394 may direct processing system 1398 to operate as described herein for at least the various processes, such as the processes 300, operational scenarios, and sequences discussed in the foregoing implementations. Computing apparatus 1390 may optionally include additional devices, features, or functionality not discussed for purposes of brevity.

In some embodiments, processing system 1398 may comprise a micro-processor and other circuitry that retrieves and executes software 1394 from storage system 1392. Processing system 1398 may be implemented within a single processing device but may also be distributed across multiple processing devices or sub-systems that cooperate in executing program instructions. Examples of processing system 1398 may include general purpose central processing units, graphical processing units, application specific processors, and logic devices, as well as any other type of processing device, combinations, or variations thereof.

Storage system 1392 may comprise any memory device or computer readable storage media readable by processing system 1398 and capable of storing software 1394. Storage system 1392 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1392 may also include computer readable communication media over which at least some of software 1394 may be communicated internally or externally. Storage system 1392 may be implemented as a single storage device but may also be implemented across multiple storage devices or sub-systems co-located or distributed relative to each other. Storage system 1392 may comprise additional elements, such as a controller, capable of communicating with processing system 1398 or possibly other systems.

Software 1394 (including data preparation process 1396 among other functions) may be implemented in program instructions that may, when executed by processing system 1398, direct processing system 1398 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1394 may include additional processes, programs, or components, such as operating system software, virtualization software, or other application software. Software 1394 may also comprise firmware or some other form of machine-readable processing instructions executable by processing system 1398.

In general, software 1394 may, when loaded into processing system 1398 and executed, transform a suitable apparatus, system, or device (of which computing apparatus 1390 is representative) overall from a general-purpose computing system into a special-purpose computing system as described herein. Indeed, encoding software 1394 on storage system 1392 may transform the physical structure of storage system 1392. The specific transformation of the physical structure may depend on various factors in different implementations of this description. Examples of such factors may include, but are not limited to, the technology used to implement the storage media of storage system 1392 and whether the computer-storage media are characterized as primary or secondary storage, as well as other factors.

For example, if the computer readable storage media are implemented as semiconductor-based memory, software 1394 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1397 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media.

Communication between the computing apparatus 1390 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more memory devices or computer-readable storage medium(s) having computer readable program code embodied thereon.

The foregoing examples and descriptions are described herein in the context of systems and methods for performing the data preparation process or providing a data preparation engine. Those of ordinary skill in the art will realize that these descriptions are illustrative only and are not intended to be in any way limiting. Reference is made in detail to implementations of examples as illustrated in the accompanying drawings. The same reference indicators are used throughout the drawings and the description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. That is, the foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in an embodiment,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all the following interpretations of the word: any of the items in the list, all the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A computing apparatus comprising:
a computer-readable storage medium;
a data preparation engine comprising processor-executable instructions stored on the computer-readable storage medium; and
one or more processors coupled to the computer-readable storage medium and configured to execute the processor-executable instructions to operate the data preparation engine, such that the processor-executable instructions, when executed by the one or more processors, direct the computing apparatus, to at least:
determine a plurality of files from one or more distributed sources;
anonymize sensitive data within one or more files of the plurality of files to generate one or more sanitized files;
generate a data collection comprising the one or more sanitized files; and
generate a data output comprising the data collection for integration into a machine-learning or artificial intelligence workflow.

2. The computing apparatus of claim 1, wherein the processor-executable instructions to anonymize the sensitive data within the one or more files further direct the computing apparatus to:
identify applicable regulatory policies governing the sensitive data;
generate the one or more sanitized files by modifying the sensitive data within the one or more files in accordance with the applicable regulatory policies; and
provide an indication of a compliance status of the sensitive data with respect to the applicable regulatory policies within a respective file of the one or more sanitized files.

3. The computing apparatus of claim 1, wherein the processor-executable instructions to generate the data output direct the computing apparatus to:
deploy the data collection to an artificial intelligence cluster or provide access information for accessing the data collection via an application programming interface.

4. The computing apparatus of claim 1, wherein the processor-executable instructions further direct the computing apparatus to:
index the plurality of files using content-based classification based on semantic meaning and contextual information of the plurality of files;
determine access permission requirements for the plurality of files based on the content-based classification; and
implement role-based access controls for the plurality of files based on the access permission requirements.

5. The computing apparatus of claim 1, wherein the processor-executable instructions direct the computing apparatus to:
detect changes to source data within the one or more distributed sources;
identify new files that match criteria of the data collection;
determine new sensitive data within the new files;
anonymize the new sensitive data within the new files to generate new sanitized files; and
automatically update the data collection to comprise the new sanitized files.

6. The computing apparatus of claim 1, wherein:
the processor-executable instructions further direct the computing apparatus to:
generate, using a data embedding module, a plurality of embeddings for the plurality of files based on semantic content analysis; and
store, using the data embedding module, the plurality of embeddings in a vector database; and
the processor-executable instructions to generate the data collection comprising the one or more sanitized files further direct the computing apparatus to:
receive a query from a client device; and
perform, by the embedding module, a semantic search on the plurality of embeddings to identify the one or more sanitized files based on the query.

7. A method comprising:
receiving, by a data preparation engine, a query from a client device;
determining, by the data preparation engine, a plurality of files from one or more distributed sources based on the query;
determining, by the data preparation engine, sensitive data within the one or more files of the plurality of files;
anonymizing, by the data preparation engine, the sensitive data within the one or more files to generate anonymized data;
generating, by the data preparation engine, a data collection that includes the plurality of files comprising the anonymized data; and
deploying, by the data preparation engine, the data collection in one or more downstream workflows.

8. The method of claim 7, further comprising:
ingesting, by the data preparation engine, the plurality of files from the one or more distributed sources; and
indexing, by the data preparation engine, the plurality of files using content-based classification based on semantic meaning and contextual information of the plurality of files.

9. The method of claim 7, anonymizing, by the data preparation engine, the sensitive data within the one or more files comprises:
identifying, by the data preparation engine, applicable regulatory policies governing the sensitive data;
modifying, by the data preparation engine, the sensitive data within the one or more files in accordance with the applicable regulatory policies; and
providing, by the data preparation engine, an indication of a compliance status of the sensitive data with respect to the applicable regulatory policies within a respective file of the one or more files.

10. The method of claim 7, further comprising:
continuously monitoring, by the data preparation engine, the one or more distributed sources for new files that match criteria of the data collection;
automatically processing, by the data preparation engine, the new files through identification and anonymization protocols; and
integrating, by the data preparation engine, the new files into the data collection in real-time.

11. The method of claim 7, further comprising:
implementing, by the data preparation engine, role-based access controls for the data collection;
tracking, by the data preparation engine, user access patterns to the plurality of files; and
generating, by the data preparation engine, an audit log of data collection activities based on user access patterns.

12. The method of claim 7, wherein determining, by the data preparation engine, the plurality of files from one or more distributed sources based on the query further comprises:
generating, by the data preparation engine, embeddings for the plurality of files using a data embedding module;
storing, by the data preparation engine, the embeddings in a vector database; and
performing, by the data preparation engine, semantic searches on the embeddings to identify files relevant to the query.

13. The method of claim 7, further comprising:
detecting, by the data preparation engine, suspicious data access patterns by analyzing user behavior and data retrieval volumes;
implementing, by the data preparation engine, data loss prevention techniques to monitor outbound data transfers; and
applying, by the data preparation engine, watermarking to the data collection to enable traceability of data usage.

14. The method of claim 7, further comprising:
integrating, by the data preparation engine, the data collection with a retrieval-augmented generation system;
establishing, by the data preparation engine, secure API endpoints for accessing the data collection; and
enabling, by the data preparation engine, the retrieval-augmented generation system to query the data collection while maintaining data privacy protections.

15. A computer-readable storage medium comprising processor-executable instructions configured to cause one or more processors to:
receive, by a data preparation engine, a query from a client device;
determine, by the data preparation engine, a plurality of files from one or more distributed sources based on the query;
index, by the data preparation engine, the plurality of files using content-based classification;
determine, by the data preparation engine, sensitive data within one or more files of the plurality of files;
generate, by the data preparation engine, a data collection comprising the plurality of files; and
generate, by the data preparation engine, a data output comprising the data collection for integration into a downstream application workflow.

16. The computer-readable storage medium of claim 15, wherein the processor-executable instructions further direct the one or more processors to:
identify, by the data preparation engine, access permission requirements based on the sensitive data and content-based classification of the plurality of files; and
implement, by the data preparation engine, role-based access controls to restrict user access to the plurality of files according to the permission requirements.

17. The computer-readable storage medium of claim 15, wherein the processor-executable instructions further direct the one or more processors to:
anonymize, by the data preparation engine, the sensitive data within the one or more files by performing at least one of masking, tokenization, generalization, perturbation, or synthetic data generation while preserving context and integrity of the sensitive data.

18. The computer-readable storage medium of claim 15, wherein the processor-executable instructions to index, by the data preparation engine, the plurality of files using content-based classification direct the one or more processors to:
generate, by a data embedding module of the data preparation engine, embeddings for the plurality of files based on semantic content analysis;
store, by the data preparation engine, the embeddings in a vector database; and
index, by the data preparation engine, the plurality of files according to content-based classification using the embeddings.

19. The computer-readable storage medium of claim 15, wherein the processor-executable instructions further direct the one or more processors to:
continuously monitor, by the data preparation engine, the one or more distributed sources for changes to source data;
identify, by the data preparation engine, new files that match criteria of the data collection;
automatically process, by the data preparation engine, the new files through identification and anonymization protocols; and
update, by the data preparation engine, the data collection to comprise the new files in real-time.

20. The computer-readable storage medium of claim 15, wherein the processor-executable instructions further direct the one or more processors to:
track, by the data preparation engine, user access patterns to the plurality of files; and
generate, by the data preparation engine, an audit log of data collection activities.
